(19) United States
(12) Patent Application Publication
(10) Pub. No.: US 2011/0168693 A1
(43) Pub. Date: Jul. 14, 2011

(54) METHOD AND APPARATUS FOR DETERMINING A WELDING PROCESS PARAMETER

(75) Inventors: Wayne RUDD, Ponteland (GB); Denis BRADBURY, Stockton-on-Tees (GB); James BURNELL-GRAY, Washington (GB); Per Thomas MOE, Drammen (NO); Kjell RABBEN, Rokland (NO); Bjorn HALMRAST, Trondheim (NO); Jan Inge AUDESTAD, Trondheim (NO)

(73) Assignee: TUBEFUSE APPLICATIONS V.O.F, Rijswijk (NL)

(21) Appl. No.: 12/686,439

(22) Filed: Jan. 13, 2010

(30) Foreign Application Priority Data
Jan. 12, 2010 (GB) 1000415.8

(51) Int. Cl. H05B 6/02; B23K 20/00; B23K 37/00

(52) U.S. Cl. 219/600; 228/102; 228/9

(57) ABSTRACT

A method of determining a welding process parameter for an object comprises subjecting a specimen removed from the object to a controlled specimen welding process, measuring a property of the specimen, and determining a welding process parameter associated with the object from the measured specimen property and the controlled specimen welding process. In one disclosed embodiment the method permits the determination of a welding process parameter of a full scale pipe by use of a specimen removed from the pipe, or a similar pipe.

### FIELD OF THE INVENTION

The present invention relates to a method and apparatus for determining a welding process step and, particularly though not exclusively, for determining a welding process step for welding pipes.

### BACKGROUND OF THE INVENTION

Forge or pressure welding can be used to join objects such as steel objects and objects formed from other metals. In an initial step, the objects are heated while surface oxides are reduced by an active gas. As the ends of the objects reach a sufficiently high temperature, the objects are pressed together. The objects may also be cooled at a pre-set rate to obtain a desired microstructure. Post-weld heat treatment may also include re-heating and rapid cooling/quenching. Other steps may also be included in the forge welding process such as pre-weld heating.

The development of a new forge welding process may be expensive. This is particularly true when developing a forge welding process for oilfield tubulars and when welding qualification trials are required.

### SUMMARY OF THE INVENTION

According to a first aspect of the present invention there is provided a method for determining a welding process parameter for an object, comprising:
subjecting a specimen removed from the object to a controlled specimen welding process;
measuring a property of the specimen; and
determining a welding process parameter associated with the object from the measured specimen property and the controlled specimen welding process.

Such a method allows full scale welding process parameters to be determined from the results of small-scale welding process experiments performed, for example, in a laboratory environment on small-scale specimens. This may result in reduced times and costs for the development and optimisation of a full-scale welding process. This is because the operating expenses, capital expenses and material costs associated with small-scale welding process experiments may be lower than corresponding costs for full-scale welding process experiments which are typically performed in prior art arrangements. In addition, it may be less time-consuming and more cost-effective to make modifications to small-scale experimental equipment to accommodate different object configurations or welding process steps than to make modifications to full-scale experimental equipment. The method also allows small-scale welding process experiments to be performed with a specimen smaller in size than the full-scale object from which the specimen is removed. This may be important during the development of a welding process when material availability may be limited. Furthermore, during testing of an object subjected to a full-scale welding process step, there may be significant experimental noise that can obfuscate results from full-scale welding process experiments. This is especially true when full-scale welding process experiments are performed in the field. The method may eliminate or at least reduce such experimental noise.

The specimen may be removed from a pipe.

The specimen may comprise a portion of a curved wall of a pipe. Such a specimen may conveniently be referred to as a coupon specimen.

The specimen may have an outer dimension that is less than a wall thickness of the object from which the specimen is removed. For example, the specimen may have an outer diameter that is less than a wall thickness of the object from which the specimen is removed.

The method may comprise removing the specimen from the object.

The method may comprise removing the specimen from a pipe.

The method may comprise subjecting a specimen removed from the object to controlled specimen welding conditions, parameters and/or envelopes or the like.

The method may comprise subjecting a specimen removed from the object to part of a controlled specimen welding process. For example, the method may comprise subjecting a specimen removed from the object to one or more steps of a controlled specimen welding process.

The method may comprise processing the specimen so as to have a predetermined feature such as size, shape, surface profile, surface roughness, surface finish, mechanical properties or the like in any combination thereof.

The method may comprise subjecting the specimen to a controlled surface treatment.

The method may comprise processing the specimen so as to have a cylindrical or rod shape.

The method may comprise processing the specimen so as to have a pipe shape.

The method may comprise processing a portion of the specimen.

The method may comprise processing an end of the specimen. The method may comprise forming a geometrical feature such as a bevel on an end portion of the specimen.

The method may comprise subjecting the specimen to controlled shaping, forming or machining or the like in any combination thereof. For example, the method may comprise subjecting the specimen to a controlled milling, drilling, spark-erosion, cutting, breaking, turning, polishing, grinding, bending, compressing, stretching, deforming, expansion or swaging step or the like in any combination thereof.

The method may comprise forming the specimen so that the specimen can be used directly for tensile testing. For example, the method may comprise shaping, forming or machining at least a portion of the specimen to permit gripping thereof during tensile testing. The method may comprise shaping, forming or machining a first portion of the specimen so as to have a greater outer dimension than a second portion of the specimen.

The method may comprise forming a hole through the specimen. The method may comprise forming first and second holes from respective first and second ends of the specimen, wherein the first and second holes may meet at a point between the first and second ends. The first and second holes may have different dimensions. For example, the first and second holes may have different diameters.

The method may comprise subjecting the specimen to a controlled specimen welding process step for a predetermined period of time.

The method may comprise subjecting at least a portion of the specimen to a controlled specimen welding process step.

The method may comprise controlling a property of the specimen.

The method may comprise controlling a physical attribute of the specimen such as temperature, stress, size, shape, surface profile, surface roughness, surface finish or the like in any combination thereof.

The method may comprise controlling a material property of the specimen such as microstructure, chemistry, metallurgy, resistance, resilience, ductility, hardness, strength, a visco-plastic material parameter or the like in any combination thereof.

The method may comprise controlling the application of an external stimulus to the specimen such as heat, pressure, force, current, voltage, electric power, electromagnetic power, electric field, magnetic field, acoustic power, ultrasonic power or the like in any combination thereof.

The method may comprise exposing at least a portion of the specimen to a controlled environment. The method may comprise exposing at least a portion of the specimen to a controlled atmosphere, having a controlled composition, temperature, pressure or the like in any combination thereof.

The method may comprise exposing at least a portion of the specimen to a fluid.

The method may comprise controlling a property of a fluid to which at least a portion of the specimen is exposed, such as a composition, temperature, pressure or the like in any combination thereof of the fluid. The fluid may comprise a gas. The fluid may comprise a mixture of gases. The fluid may comprise a reducing gas, such as nitrogen, hydrogen, carbon monoxide, methane or the like, or any combination thereof. A reducing gas may be provided to assist in the removal of undesirable components, such as oxides, from the specimen. The fluid may comprise an inert gas. An inert gas may be used to assist to isolate the specimen from adverse reactions with normal atmosphere, for example to isolate from oxygen in the atmosphere which may otherwise result in the formation of oxides. The fluid may comprise a cooling fluid.

The method may comprise adjusting a temperature of at least a portion of the specimen to a target temperature. The method may comprise adjusting a temperature of at least a portion of the specimen to a target temperature within a target time period. The method may comprise adjusting a temperature of at least a portion of the specimen to within a predetermined degree of accuracy of a target temperature within a target time period. The method may comprise maintaining a temperature of at least a portion of the specimen over a time period. The method may comprise maintaining a temperature of at least a portion of the specimen to within a predetermined degree of accuracy of a target temperature over a time period. The method may comprise adjusting a temperature of at least a portion of the specimen so that a temperature of at least a portion of the specimen follows a predetermined temporal temperature profile. The method may comprise adjusting a temperature of at least a portion of the specimen so as to achieve a predetermined spatial temperature distribution across at least a portion of the specimen.

The method may comprise adjusting a temperature of a bevelled end portion of a pipe shaped specimen so as to achieve a predetermined spatial temperature distribution across the bevelled end portion of the pipe shaped specimen.

The method may comprise adjusting a temperature of at least a portion of the specimen by heating or cooling the specimen.

The method may comprise subjecting a body to the same controlled specimen welding process step to which the specimen is subjected.

The body may comprise a further specimen removed from the object.

The method may comprise removing the body from the object.

The body may comprise a further specimen removed from a further object.

The method may comprise removing the body from the further object.

The step of subjecting the specimen to a controlled specimen welding process step may comprise engaging the specimen with the body under controlled conditions.

The method may comprise engaging the specimen with the body under the action of a predetermined force.

The method may comprise engaging the specimen with the body for a predetermined period of time.

The method may comprise engaging the specimen with the body according to a temperature of the specimen and/or a temperature of the body.

The method may comprise creating a predetermined interference of the specimen with the body.

The method may comprise welding the specimen and the body under controlled conditions.

The method may comprise forge welding the specimen and the body under controlled conditions.

The method may comprise welding an end of the specimen and an end of the body together under controlled conditions.

The method may comprise heating or cooling the specimen and the body under controlled conditions after welding of the specimen and the body.

The method may comprise measuring a property of the specimen before, during and/or after the step of subjecting the specimen to the controlled specimen welding process step.

The method may comprise measuring a physical attribute of the specimen such as temperature, stress, size, shape, surface profile, roughness or the like in any combination thereof.

The method may comprise measuring a bevel shape.

The method may comprise measuring a material property of the specimen such as microstructure, chemistry, metallurgy, resistance, resilience, ductility, hardness, strength, a visco-plastic material parameter or the like in any combination thereof.

The method may comprise measuring a martensite fraction or the like.

The method may comprise performing a metallographic analysis of the specimen.

The method may comprise mechanical testing of the specimen.

The method may comprise tensile testing of the specimen. The method may comprise bending, Charpy, single edge notched tensile (SENT), single edged notched bend (SENB) or hardness testing in any combination thereof.

The method may comprise measuring a property of the specimen at or adjacent to a weld interface between the specimen and a body to which the specimen is welded.

The method may comprise measuring a weld shape.

The method may comprise testing the specimen, for example, destructively or non-destructively testing the specimen.

The method may comprise measuring a plurality of values of the property of the specimen.

The method may comprise measuring a property of the specimen at a plurality of positions across the specimen.

The method may comprise repeatedly measuring a property of the specimen over a period of time.

The method may comprise measuring a plurality of properties of the specimen.

The method may comprise:
subjecting a further specimen removed from the object to a controlled specimen welding process;
measuring a property of the further specimen; and
determining a welding process parameter associated with the object from the measured property of the further specimen, and the controlled specimen welding process to which the further specimen is subjected.

The method may comprise correlating properties measured from the specimen and the further specimen.

The method may comprise correlating welding process parameter determined from the specimen and the further specimen.

The further specimen may have a different shape and/or size to the specimen.

For example, the further specimen may have a pipe shape and the specimen may have a coupon shape.

Although the manufacture and testing of such pipe-shaped specimens is generally simpler than the manufacture and testing of coupon specimens, the use of both coupon and pipe specimens may provide complementary results. Due to the axisymmetric geometry of a pipe specimen, the analysis of the test results is often simpler for pipe specimens than for coupon specimens because for coupon specimens, edge effects must be considered and the numerical analysis is often more complex. Full-scale mechanical and chemical testing procedures may, however, be used with coupon specimens.

The method may comprise using a mathematical model of the specimen to calculate the object welding process parameter from the measured specimen property and the controlled specimen welding process.

The method may comprise using a finite element mathematical model of the specimen to calculate the object welding process parameter from the measured specimen property and the controlled specimen welding process.

The method may comprise using a mathematical model of the specimen to calculate the object welding process parameter from the measured specimen property and the controlled specimen welding process.

The method may comprise determining one or more object and specimen parameters that define any differences between an object and a corresponding specimen.

Such object and specimen parameters may, for example, define the size, shape, surface profile, microstructure and the like of the object relative to the specimen in any combination thereof.

The method may comprise dimensional analysis of the object and the specimen. The method may comprise dimensional analysis of the body.

The method may comprise using a mathematical model of the specimen to calculate the object welding process parameter from the measured specimen property, the controlled specimen welding process and the one or more object and specimen parameters.

The method may comprise validating a mathematical model of the specimen welding process.

The method may comprise comparing a value of the specimen property predicted using a mathematical model with a measured value of the specimen property.

The method may comprise improving a mathematical model based on a comparison between a value of the specimen property predicted using the mathematical model and a measured value of the specimen property.

The method may comprise improving a mathematical model based on a comparison between a plurality of values of the specimen property predicted using the mathematical model and a corresponding plurality of measured values of the specimen property.

Predicting at least one value of a specimen property and comparing the at least one predicted value with a corresponding at least one measured value may facilitate the gradual improvement of the mathematical model and/or reduce the number of trials required to achieve a desired value of the specimen property.

The method may comprise deeming a mathematical model to be valid when a difference between a value of the specimen property predicted using the mathematical model and a measured value of the specimen property is less than a predetermined accuracy value.

The method may comprise adjusting a mathematical model according to a difference between a value of the specimen property predicted using the mathematical model and a measured value of the specimen property.

The method may comprise adjusting a mathematical model until a difference between a value of the specimen property predicted using the mathematical model and a measured value of the specimen property is less than a predetermined accuracy value.

The method may comprise adjusting one or more parameters and/or a functional form of a mathematical model according to a difference between a value of the specimen property predicted using the mathematical model and a measured value of the specimen property.

The method may comprise determining an object welding process parameter from a plurality of measured values of a specimen property and the controlled specimen welding process.

The method may comprise determining an object welding process parameter from a plurality of measured specimen properties and the controlled specimen welding process.

According to a second aspect of the present invention there is provided an apparatus for use in the method of the first aspect.

The apparatus may be configured to subject the specimen to a controlled specimen welding process.

The apparatus may be configured to subject a further specimen to a controlled specimen welding process.

The further specimen may have a different shape and/or size to the specimen.

For example, the further specimen may have a pipe shape and the specimen may have a coupon shape.

Although the manufacture and testing of such pipe-shaped specimens is generally simpler than the manufacture and testing of coupon specimens, the use of both coupon and pipe specimens may provide complementary results. Due to the axisymmetric geometry of a pipe specimen, the analysis of the test results is often simpler for pipe specimens than for coupon specimens because for coupon specimens, edge effects must be considered and the numerical analysis is often more complex. Full-scale mechanical and chemical testing procedures may, however, be used with coupon specimens. Arranging the apparatus to be configurable for use with both coupon and pipe specimens is therefore particularly advantageous since complementary results may be obtained with a single apparatus.

The apparatus may be configured to subject at least a portion of the specimen to a controlled specimen welding process.

The apparatus may be configured to subject the specimen to a controlled specimen welding process for a controlled period of time.

The apparatus may be configured to subject the specimen to part of a controlled specimen welding process. For example, the apparatus may be configured to subject the specimen to one or more steps of a controlled specimen welding process.

The apparatus may be configured to control a physical attribute of the specimen such as temperature, stress, size, shape, surface profile, surface roughness, surface finish or the like in any combination thereof.

The apparatus may be configured to control a material property of the specimen such as microstructure, chemistry, metallurgy, resistance, resilience, ductility, hardness, strength, a visco-plastic material parameter or the like in any combination thereof.

The apparatus may be configured to control the application of an external stimulus to the specimen such as heat, pressure, force, current, voltage, electric power, electromagnetic power, electric field, magnetic field, acoustic power, ultrasonic power or the like in any combination thereof.

The apparatus may be configured to expose at least a portion of the specimen to a controlled environment.

The apparatus may be configured to expose at least a portion of the specimen to a controlled atmosphere having a controlled composition, temperature, pressure or the like in any combination thereof.

The apparatus may be configured to expose at least a portion of the specimen to a fluid.

The apparatus may comprise a specimen enclosure for enclosing at least a portion of the specimen in a controlled environment. The specimen enclosure may comprise a fluid inlet port and a fluid outlet port.

The specimen enclosure may comprise a fluid inlet port defined by the specimen and/or a fluid outlet port defined by the specimen.

The fluid may comprise a gas. The fluid may comprise a mixture of gases. The fluid may comprise a reducing gas, inert gas, cooling fluid or the like.

The apparatus may comprise a fluid supply for supplying fluid to at least a portion of the specimen. The fluid supply may be configured to control a property of the fluid, such as a temperature, pressure, flow rate and/or composition of the fluid.

The apparatus may comprise a plurality of fluid inlet ports formed in the specimen enclosure. For example, the apparatus may comprise a plurality of fluid inlet nozzles formed in the specimen enclosure. The fluid inlet ports may be directed inwards towards an end of the specimen, for example, towards a heated end of the specimen.

The fluid supply may be configured to vary the rate of supply of fluid to different fluid inlet ports.

The fluid supply may be configured to supply fluid to different fluid inlet ports at different times. For example, the fluid supply may be configured to supply fluid to a first fluid inlet port formed in the specimen enclosure at a first time and to supply fluid to a second fluid inlet port formed in the specimen enclosure at a position opposite the first fluid inlet port at a second time before or after the first time.

The apparatus may comprise a cooling arrangement for cooling at least a portion of the specimen. For example, the apparatus may comprise a coolant fluid supply, a coolant fluid chamber surrounding at least a portion of the specimen and a coolant fluid conduit connecting the coolant fluid supply to the coolant fluid chamber.

The apparatus may comprise an electrical heating arrangement for heating at least a portion of the specimen.

The apparatus may be configured for use with or comprise an electrical supply for providing electrical power, current and/or voltage to the electrical heating arrangement.

The apparatus may be configured for use with or comprise a supply of high frequency alternating current.

The apparatus may comprise a pair of electrical conductors for connecting the electrical supply to the electrical heating arrangement.

The apparatus may comprise a pair of electrodes configured to contact the specimen for the supply of a current thereto.

The pair of electrodes may be movable relative to the specimen. For example, the apparatus may comprise an electrode fixing arrangement configured to permit movement of an electrode relative to the specimen or an electrode actuator for moving an electrode relative to the specimen.

The apparatus may comprise an induction heater. For example, the apparatus may comprise a coil for induction heating.

The induction heater may be movable relative to the specimen. For example, the apparatus may comprise an induction heater fixing arrangement configured to permit movement of the induction heater relative to the specimen or an induction heater actuator for moving the induction heater relative to the specimen.

The apparatus may comprise a pair of plates wherein the plates are spaced apart. The apparatus may comprise at least one tension rod wherein the at least one tension rod connects the pair of plates so as to form a frame.

The apparatus may be configured to hold the specimen. For example, the apparatus may comprise a specimen holding arrangement such as a gripping device or a chuck or the like. The specimen holding arrangement may be hydraulically activated. The specimen holding arrangement may be attached to the frame. The specimen holding arrangement may be configured to grip at least a portion of the specimen specifically shaped to permit gripping thereof.

The apparatus may comprise a specimen feeding arrangement for feeding specimens into the specimen holding arrangement. For example, the apparatus may comprise a specimen carousel such as an indexable specimen carousel for feeding specimens into the specimen holding arrangement.

The apparatus may be configured to hold a body. For example, the apparatus may comprise a body holding arrangement such as a gripping device or a chuck or the like. The body holding arrangement may be hydraulically activated. The body holding arrangement may be attached to the frame. The body holding arrangement may be configured to grip at least a portion of the body specifically shaped to permit gripping thereof.

The apparatus may comprise a body feeding arrangement for feeding bodies into the body holding arrangement. For example, the apparatus may comprise a body carousel such as an indexable body carousel for feeding bodies into the body holding arrangement.

The body may comprise a further specimen removed from the object.

The body may comprise a further specimen removed from a further object.

The apparatus may comprise a cooling arrangement for cooling at least a portion of the body. For example, the apparatus may comprise a coolant fluid supply, a coolant fluid chamber surrounding at least a portion of the body and a coolant fluid conduit connecting the coolant fluid supply to the coolant fluid chamber.

The apparatus may comprise a specimen coolant fluid chamber surrounding at least a portion of the specimen, a body coolant fluid chamber surrounding at least a portion of the body and a coolant fluid conduit connecting the specimen coolant fluid chamber and the body coolant fluid chamber.

The apparatus may comprise a further pair of electrodes configured to contact the body for the supply of a current thereto.

The pair of electrodes configured to contact the specimen and the further pair of electrodes configured to contact the body may be connected in series.

The apparatus may comprise an induction heater configured to heat the specimen and the body.

The induction heater may be movable relative to the specimen and the body so as to remain symmetrically positioned relative to a weld interface between the specimen and the body. The apparatus may be configured to provide relative movement between the specimen and the body.

The apparatus may be configured to bring the specimen and the body into contact.

The apparatus may be configured to exert a force between the specimen and the body.

The apparatus may comprise a specimen actuator for urging the specimen towards the body. The specimen actuator may, for example, be configured to urge the specimen holding arrangement towards the body.

The specimen actuator may be attached to the frame. The specimen actuator may extend through an aperture in one of the pair of plates.

The specimen actuator may comprise an electromechanical actuator and/or a hydraulic actuator or the like.

The apparatus may comprise a body actuator for urging the body towards the specimen. The body actuator may, for example, be configured to urge the body holding arrangement towards the specimen.

The body actuator may be attached to the frame. The body actuator may extend through an aperture in one of the pair of plates.

The body actuator may comprise an electromechanical actuator and/or a hydraulic actuator or the like.

The apparatus may be configured to measure a property of a specimen. The apparatus may be configured to measure a property of a specimen before, during or after subjecting the specimen to a controlled specimen welding process using the apparatus. For example, the apparatus may comprise a sensor for measuring a property of the specimen.

The apparatus may comprise a specimen sensor for measuring a property of the specimen at or adjacent to a weld interface between the specimen and a body to which the specimen is welded.

The apparatus may comprise a specimen sensor for measuring a temperature, stress, size, shape, surface profile, surface roughness, surface finish or the like of the specimen in any combination thereof.

The apparatus may comprise a pyrometer, thermal camera, thermometer, thermocouple, thermistor, resistance temperature detector or the like in any combination thereof for measuring a temperature of the specimen.

The apparatus may comprise an optical system such as an imaging system, microscope or the like for measuring a size, shape, surface profile, surface roughness, surface finish or the like of the specimen.

The apparatus may comprise an acoustic sensor or an ultrasonic sensor or the like for measuring a size, shape, surface profile, surface roughness, surface finish or the like of the specimen.

The apparatus may comprise a strain gauge or the like for measuring a strain of the specimen indicative of stress in the specimen.

The apparatus may comprise a specimen sensor for measuring a force exerted on the specimen.

The apparatus may comprise a load cell or the like for measuring a force exerted on the specimen.

The apparatus may comprise a specimen sensor for measuring a position of the specimen.

The apparatus may comprise a vision system, a linear or rotary encoder or the like.

The apparatus may comprise a specimen sensor for measuring a material property of the specimen such as microstructure, chemistry, metallurgy, resistance, resilience, ductility, hardness, strength, a visco-plastic material parameter or the like in any combination thereof.

The apparatus may be configured to perform pull and/or hardness tests after subjecting the specimen to a controlled specimen welding process using the apparatus.

The apparatus may comprise one or more specimen environment sensor for measuring a property of an environment to which at least a portion of the specimen in exposed.

A specimen environment sensor may be configured for measuring a composition, temperature, pressure or the like of an atmosphere to which at least a portion of the specimen is exposed in any combination thereof.

A specimen environment sensor may be configured for measuring a property of a fluid to which at least a portion of the specimen is exposed.

A specimen environment sensor may be configured for measuring a composition temperature, pressure, and/or flow rate of a fluid to which at least a portion of the specimen is exposed.

The apparatus may comprise a remote specimen sensor.

The apparatus may comprise a remote specimen environment sensor.

The apparatus may comprise a controller.

The controller may be configured for communication with the specimen sensor, the specimen environment sensor, the electrical supply, the specimen actuator, the body actuator and/or the fluid supply.

The controller may be configured to control the electrical supply, the specimen actuator, the body actuator and/or the fluid supply according to a measured value of a property of the specimen provided by the specimen sensor and/or the specimen environment sensor.

Aspects of the present invention may have application in determining a welding process parameter for an oilfield object, such as an oilfield tubular, for example a casing tubular, liner tubular, production tubular or the like.

### BRIEF DESCRIPTION OF THE DRAWINGS

The present invention will be further described by way of non-limiting example only with reference to the following figures of which:

FIG. 1 is a flow chart illustrating a method for determining a welding process step constituting a first embodiment of the present invention;

FIG. 2(a) is a schematic drawing illustrating the relationship between a pipe object and a plurality of coupon specimens formed from the pipe object;

FIG. 2(b) is a schematic drawing illustrating the relationship between a pipe object and a plurality of pipe specimens formed from the pipe object;

FIG. 3 is a flow chart illustrating a method for determining a welding process step constituting a second embodiment of the present invention;

FIG. 4 is a schematic perspective view of an apparatus for subjecting two generally cylindrical specimens to a controlled specimen welding process step constituting a third embodiment of the present invention wherein an enclosure of the apparatus is shown in an open configuration;

FIG. 5 is a cross-section of the apparatus of FIG. 4 on a vertical plane passing through lines AA and BB shown in FIG. 4 when the enclosure is in a closed configuration;

FIG. 6 is a cross-section of a portion of the apparatus of FIG. 4 on a vertical plane showing the electrode electrical connections;

FIG. 7 is a schematic diagram illustrating the configuration of an electrical circuit connecting the electrodes of the apparatus of FIG. 4 to an electrical power supply;

FIG. 8 is a schematic perspective view of an apparatus for subjecting two pipe specimens to a controlled specimen welding process step constituting a fourth embodiment of the present invention;

FIG. 9 is a cross-section of the apparatus of FIG. 8 including an enclosure in a closed configuration wherein the cross-section is taken on a vertical plane passing through lines AA and BB shown in FIG. 8;

FIG. 10 is a schematic diagram illustrating the configuration of an electrical circuit connecting an induction heating coil of the apparatus of FIG. 8 to an electrical power supply; and

FIG. 11 is a cross-section of a portion of the apparatus of FIG. 8 on a vertical plane passing through lines CC and DD shown in FIG. 8.

### DETAILED DESCRIPTION OF THE DRAWINGS

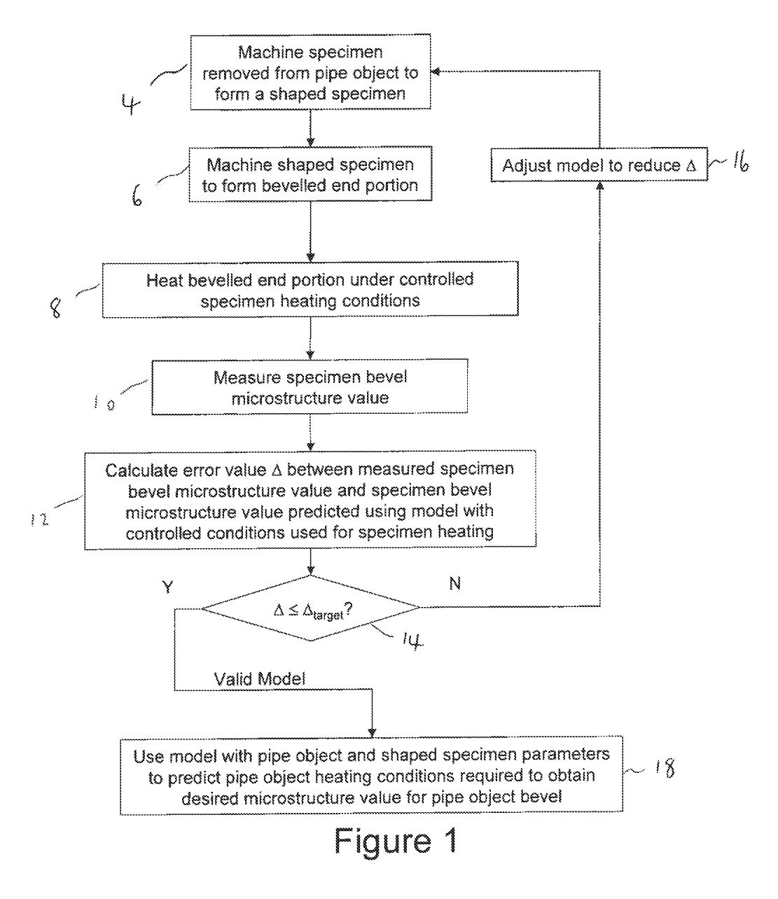

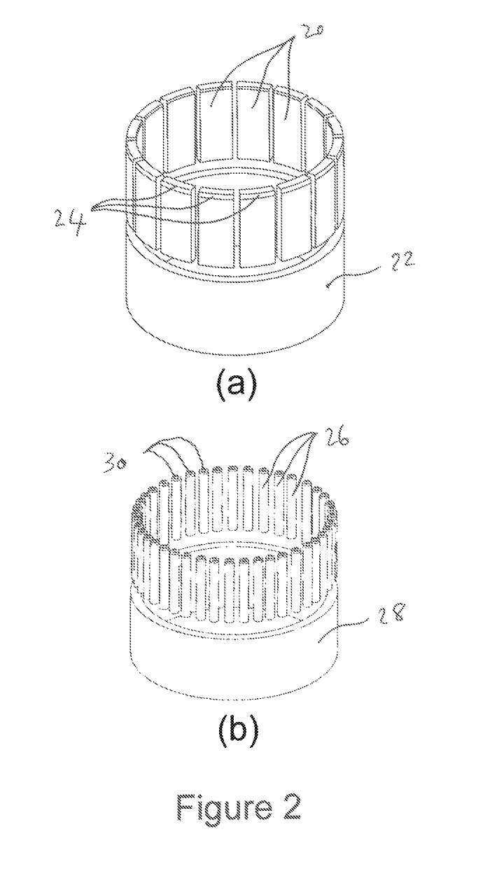

FIG. 1 illustrates a first embodiment of a method for determining a welding process step for a pipe object. The method begins at step 4, in which a specimen removed from the pipe object is machined so as to form a shaped specimen. At step 6 an end portion of the shaped specimen is machined to form a bevelled end portion. Examples of shaped specimens resulting from the machining operations of steps 4 and 6 are shown in FIGS. 2(a) and 2(b). FIG. 2(a) shows a plurality of coupon specimens 20 formed from a pipe 22. Each coupon specimen 20 extends parallel to a longitudinal axis of the pipe 22 and extends circumferentially part way around a circumference of the pipe 22. Each coupon specimen 20 has a bevelled end portion 24. FIG. 2(b) shows a plurality of pipe specimens 26 formed from a pipe 28. Each pipe specimen 26 has a diameter less than or equal to a sidewall thickness of the pipe 28. Each pipe specimen 26 has a bevelled end portion 30.

The method continues at step 8, which comprises heating an end portion of the shaped specimen under controlled specimen heating conditions. Subsequently at step 10, the method comprises measuring a value associated with or representative of a microstructure of the bevelled end portion of the shaped specimen during or after heating of the bevelled end portion of the shaped specimen.

The method continues at step 12, which comprises calculating a model error value A between the measured value of the specimen bevel microstructure and a value of the specimen bevel microstructure predicted using a finite element mathematical model of the specimen material with the controlled conditions used for the heating step 8. The calculated model error value Δ is compared with a desired target model error value Δ_{target} at step 14. If the calculated model error value A is greater than the target model error value Δ_{target}, the mathematical model is adjusted at step 16 to reduce the calculated model error value A and the method steps 4, 6, 8, 10, 12 and 14 are repeated. If the calculated model error value A is less than or equal to the target model error value Δ_{target}, the model of the specimen material is deemed to be valid and is used at step 18 to predict the pipe object heating conditions required to obtain a desired object bevel microstructure value. Using the model at step 18 comprises using the model with pipe object and shaped specimen parameters that define any differences between the pipe object and the shaped specimen and that, in particular, define the size, shape, surface profile and the like of the pipe object relative to corresponding parameters of the shaped specimen.

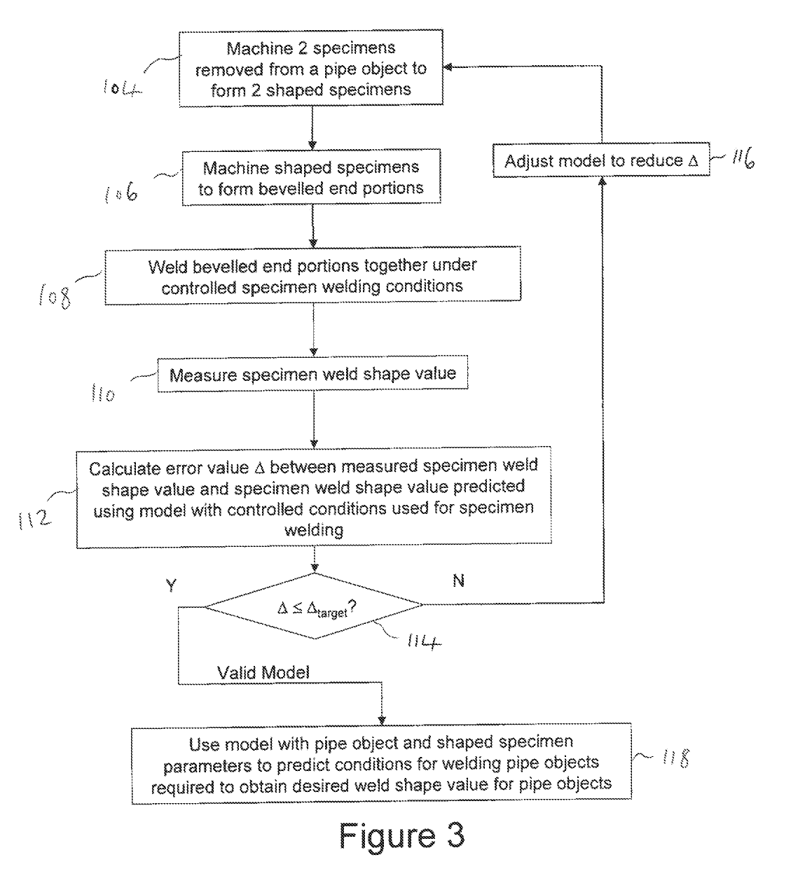

FIG. 3 illustrates a second embodiment of a method for determining a welding process step. The method of FIG. 3 comprises many of the same steps as the method of FIG. 1 and, as such, like steps share like reference numerals, incremented by 100. The method begins at step 104, in which two specimens removed from two different pipe objects are machined so as to form two shaped specimens. At step 106 end portions of the shaped specimens are machined to form bevelled end portions. The method continues at step 108, which comprises forge welding the bevelled end portions of the shaped specimens together under controlled specimen welding conditions. Subsequently at step 110, the method comprises measuring a value associated with or representative of a shape of a weld formed at an interface between the bevelled end portions of the shaped specimens during or after forge welding of the specimen end portions. The method continues at step 112 which comprises calculating a model error value Δ between the measured specimen weld shape value and a value of the specimen weld shape predicted using a finite element mathematical model of the specimen material with the controlled conditions used for the forge welding step 108. The calculated model error value A is compared with a desired target model error value Δ_{target} at step 114. If the calculated model error value Δ is greater than the target model error value Δ_{target}, the mathematical model is adjusted at step 116 to reduce the calculated model error value A and the method steps 104, 106, 108, 110, 112 and 114 are repeated. If the calculated model error value Δ is less than or equal to the target model error value Δ_{target}, the model of the specimen material is deemed to be valid and is used at step 118 to predict the pipe object welding conditions required to obtain a desired object weld shape value. Using the model at step 118 comprises using the model with pipe object and shaped specimen parameters that define any differences between the pipe objects and the shaped specimens and that, in particular, define the size, shape, surface profile and the like of the pipe objects relative to corresponding parameters of the shaped specimens.

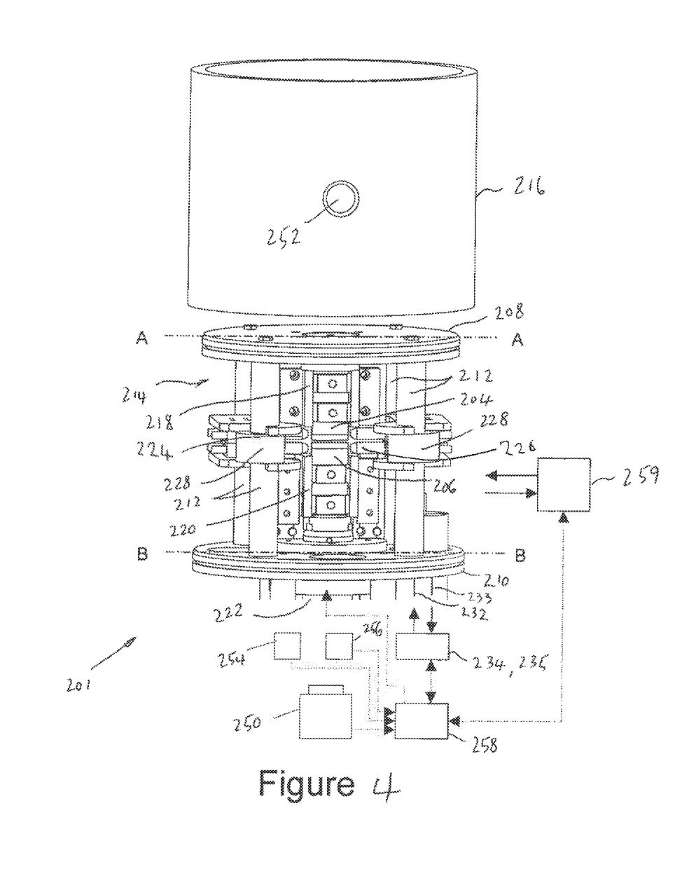

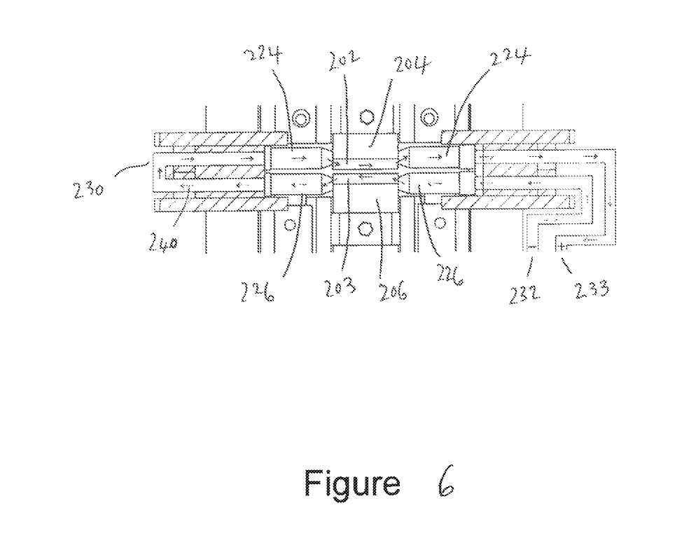

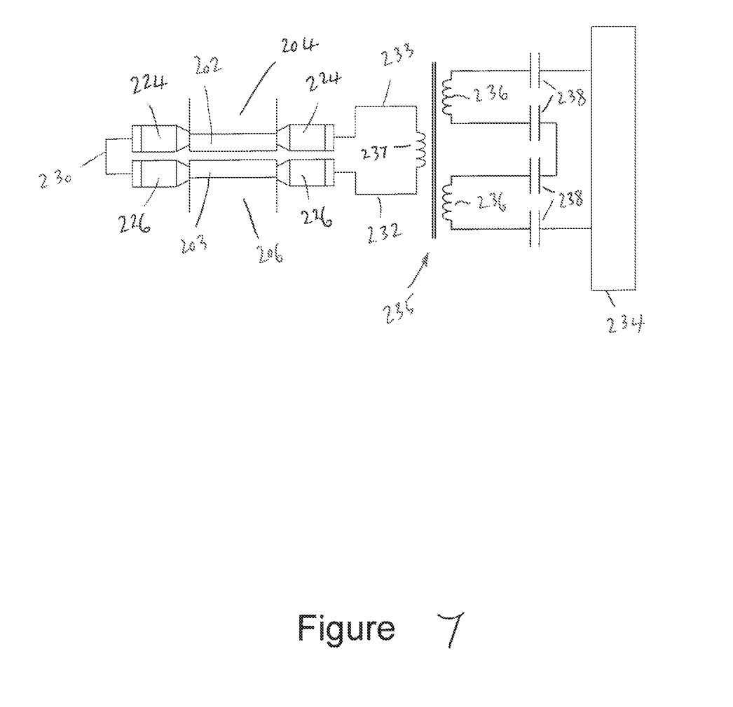

FIGS. 4 to 7 show a first embodiment of an apparatus 201 for use in heating bevelled end portions 202 and/or 203 (FIGS. 6 and 7) of upper and/or lower coupon specimens 204 and 206 respectively according to the controlled heating step 8 of the method of FIG. 1 and/or for use in forge welding the bevelled end portions 202 and 203 of upper and lower coupon specimens 204 and 206 respectively together according to the controlled welding step 108 of the method of FIG. 3. It should be understood that references to directions up, down, vertical, horizontal etc are relative to the orientation of the apparatus 201 shown in FIGS. 4 to 6. The apparatus 201 is configured so as to hold upper and lower coupon specimens 204, 206 whilst urging the lower coupon specimen 206 towards or away from the upper coupon specimen 204. The apparatus 201 comprises an upper plate 208 fixed relative to and spaced apart from a lower plate 210 by tension rods 212 so as to form a space 214 between the upper and lower plates 208, 210. The apparatus 201 further comprises an enclosure 216 that is arranged to enclose the space 214 when the enclosure is in a closed configuration shown in FIG. 4.

The apparatus 201 comprises upper and lower gripping arrangements 218, 220 for gripping and alignment of the upper and lower coupon specimens 204, 206 respectively. The apparatus 201 further comprises a hydraulically-activated actuator 222 that extends through an aperture in the lower plate 210 and is connected to the lower gripping arrangement 220. The actuator 222 is arranged to move relative to the lower plate 210 so as to urge the lower coupon specimen 206 towards or away from the upper coupon specimen 204.

In addition, the apparatus 201 comprises an upper pair of electrodes 224 for supplying high frequency alternating current to the upper coupon specimen 204 and a lower pair of electrodes 226 for supplying high frequency alternating current to the lower coupon specimen 206. The upper and lower pairs of electrodes 224, 226 are attached to the tension rods 212 by a fixing arrangement 228 that permits movement of the electrodes 224, 226 towards and away from the upper and lower coupon specimens 204, 206.

As shown in FIG. 6, the upper and lower pairs of electrodes 224 and 226 are connected in series through a conductor 230. The apparatus 201 further comprises input and output conductors 232 and 233 respectively for supplying high frequency alternating current to the electrodes 224, 226. As shown in FIG. 7, a high frequency alternating current electrical supply 234 is coupled to the input and output conductors 232 and 233 via a transformer arrangement 235 comprising primary windings 236 and a secondary winding 237. The primary windings 236 are capacitively coupled in series via capacitors 238 across the electrical supply 234. The transformer arrangement 235 and the capacitors 238 ensure that the electrical supply 234 is electrically matched to the electrical load presented by the arrangement of the electrodes 224, 226 and the bevelled end portions 202 and 203 of the upper and lower coupon specimens 204 and 206 respectively for maximum electrical power transfer thereto.

In use, as shown in FIG. 6, the upper and lower pairs of electrodes 224 and 226 are engaged with the upper and lower coupon specimens 204 and 206 at positions at or adjacent to the bevelled end portions 202 and 203 respectively and the electrical supply 234 is activated so as to drive a high frequency alternating current 240 along a current path through the bevelled end portions 202 and 203 thereby resistively heating the end portions 202 and 203.

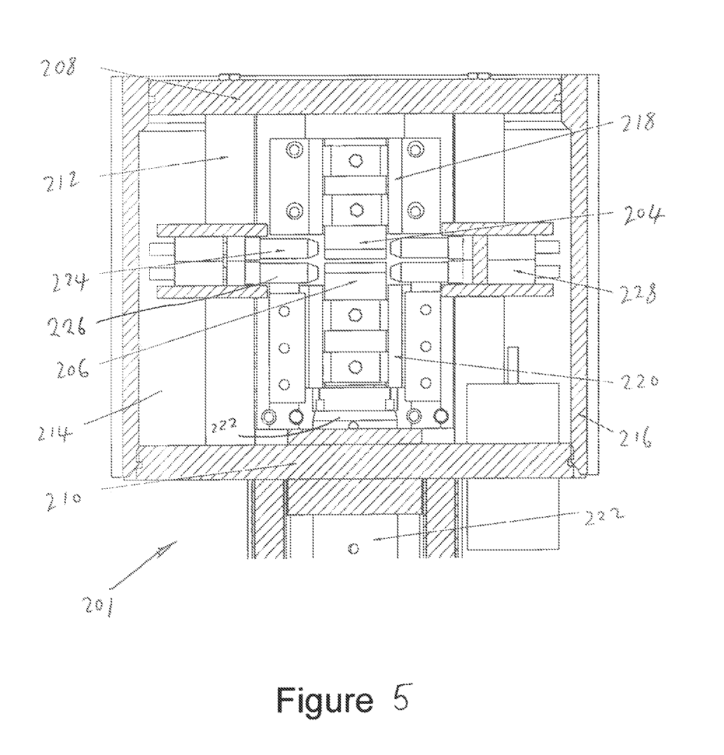

The apparatus 201 further comprises an IR camera 250 (FIG. 4) which is configured to remotely sense a temperature of the bevelled end portions 202 and 203 of the upper and lower coupon specimens 204 and 206 respectively through a sapphire window 252 in the enclosure 216 when the enclosure 216 is in the closed configuration shown in FIG. 5. Furthermore, the apparatus 201 comprises a position sensor 254 configured for measurement of a position of the actuator 222 relative to the lower plate 210 and a force sensor 256 configured for measurement of a force exerted by the actuator 222 on the lower coupon specimen 206. The apparatus 201 further comprises a controller 258 configured for communication with the actuator 222, the electrical supply 234, the IR camera 250, the position sensor 254 and the force sensor 256 as indicated by the dotted lines in FIG. 4.

The apparatus 201 also comprises a reducing gas inlet (not shown) and a reducing gas outlet (not shown) to the space 214 for the supply and removal respectively of a reducing gas comprising nitrogen and hydrogen to the bevelled end portions 202 and 203 when the enclosure 216 is in the closed configuration. The inlet and outlet are connected to a reducing gas supply 259. The reducing gas supply 259 is configured to assist in the control of a temperature, pressure, composition and flow rate of the reducing gas. The reducing gas supply 259 is also configured for communication with the controller 258.

In use, the controller 258 controls the actuator 222, the electrical supply 234 and/or the reducing gas supply 259 according to a temperature sensed by the IR camera 250, a position sensed by the position sensor 254 and/or a force sensed by the force sensor 256 so as to subject one or both of the bevelled end portions 202 and 203 to a controlled welding process step. In the case of the heating step 8 of the method 2 of FIG. 1, for example, the apparatus 201 controls the evolution as a function of time of a spatial temperature distribution across one or both of the bevelled end portions 202 and 203 in an atmosphere of reducing gas having a predetermined temperature, pressure, composition and flow rate. In the case of the welding step 108 of the method of FIG. 3, for example, the apparatus 201 controls the evolution as a function of time of a spatial temperature distribution across both of the bevelled end portions 202 and 203 in an atmosphere of reducing gas having a predetermined temperature, pressure, composition and flow rate and controls the movement of and the forces applied to the upper and lower coupon specimens 204 and 206 during forge welding thereof.

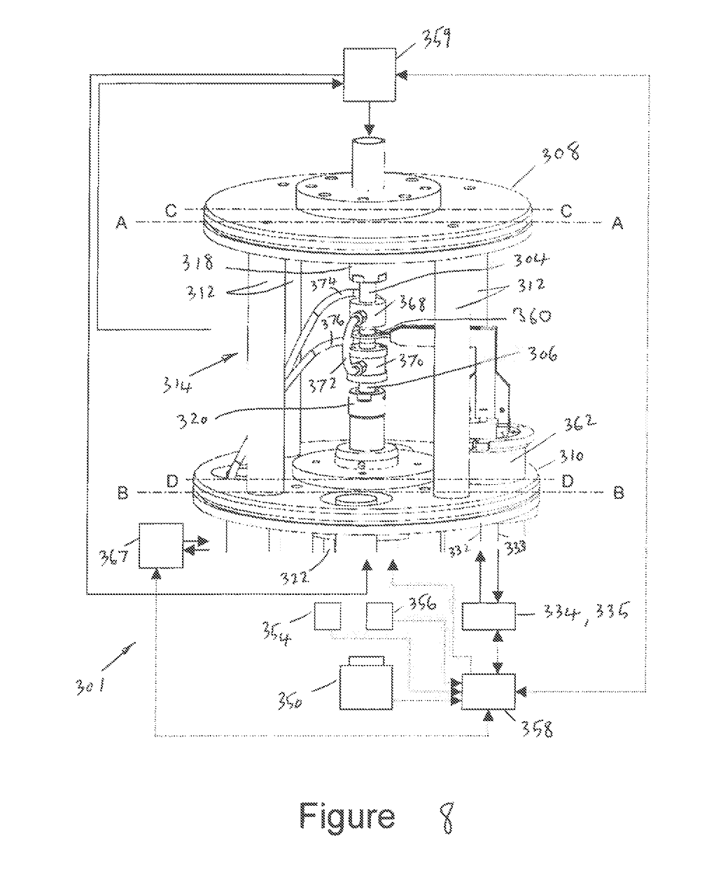

FIGS. 8 to 11 show a second embodiment of an apparatus 301 for use in heating bevelled end portions 302 and/or 303 of upper and/or lower generally pipe-shaped specimens 304 and 306 respectively according to the controlled heating step 8 of the method of FIG. 1 and/or for use in forge welding the bevelled end portions 302 and 303 of upper and lower pipe-shaped specimens 304 and 306 respectively together according to the controlled welding step 108 of the method of FIG. 3. The apparatus 301 comprises many of the same features as the apparatus 201 of FIGS. 4 to 7 and, as such, like features share like reference numerals, incremented by 100. It should be understood that references to directions up, down, vertical, horizontal etc are relative to the orientation of the apparatus 301 shown in FIGS. 8 to 11.

The apparatus 301 is configured so as to hold upper and lower pipe specimens 304, 306 whilst urging the lower pipe specimen 306 towards or away from the upper pipe specimen 304. The apparatus 301 comprises an upper plate 308 fixed relative to and spaced apart from a lower plate 310 by tension rods 312 so as to form a space 314 between the upper and lower plates 308, 310. The apparatus 301 further comprises an enclosure 316 that is arranged to enclose space 314 when the enclosure 316 is in a closed configuration shown in FIG. 8.

The apparatus 301 comprises upper and lower chucks 318 and 320 for gripping and alignment of the upper and lower pipe specimens 304 and 306 respectively. The apparatus 301 further comprises a hydraulically-activated actuator 322 that extends through an aperture in the lower plate 310 and is connected to the lower chuck 320. The actuator 322 is arranged to move relative to the lower plate 310 so as to urge the lower pipe specimen 306 towards or away from the upper pipe specimen 304.

In addition, the apparatus 301 comprises an induction coil 360 for inductively heating the bevelled end portions 302 and 303. The induction coil 360 is mounted on a base 362, which is movable relative to the lower plate 310.

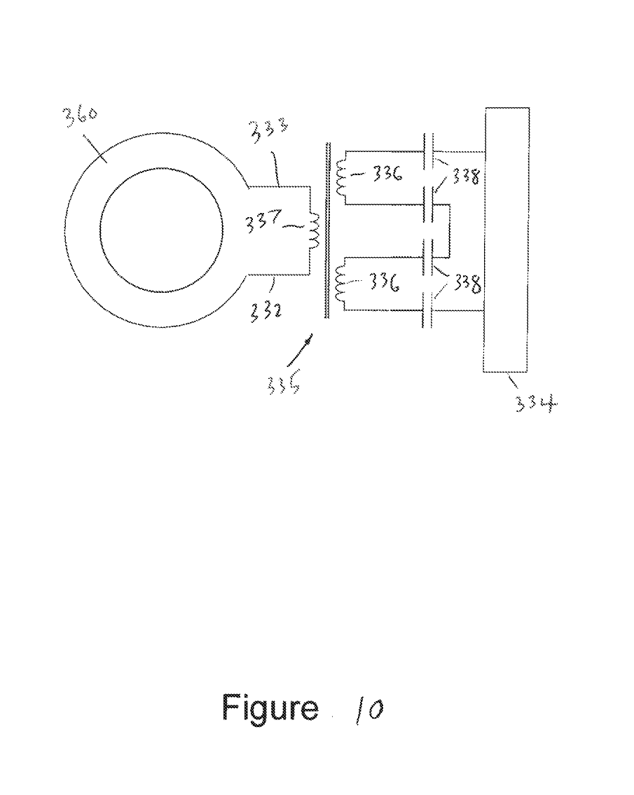

As shown in FIG. 8, the apparatus 301 further comprises input and output conductors 332 and 333 respectively for the supply of high frequency alternating current from a high frequency alternating current electrical supply 334 to the induction coil 360. As shown in FIG. 10, the electrical supply 334 is coupled to the input and output conductors 332 and 333 via a transformer arrangement 335 comprising primary windings 336 and a secondary winding 337. The primary windings 336 are capacitively coupled in series via capacitors 338 to the electrical supply 334. The transformer arrangement 335 and the capacitors 338 ensure that the electrical supply 334 is electrically matched to the electrical load presented by the induction coil 360 for maximum electrical power transfer thereto.

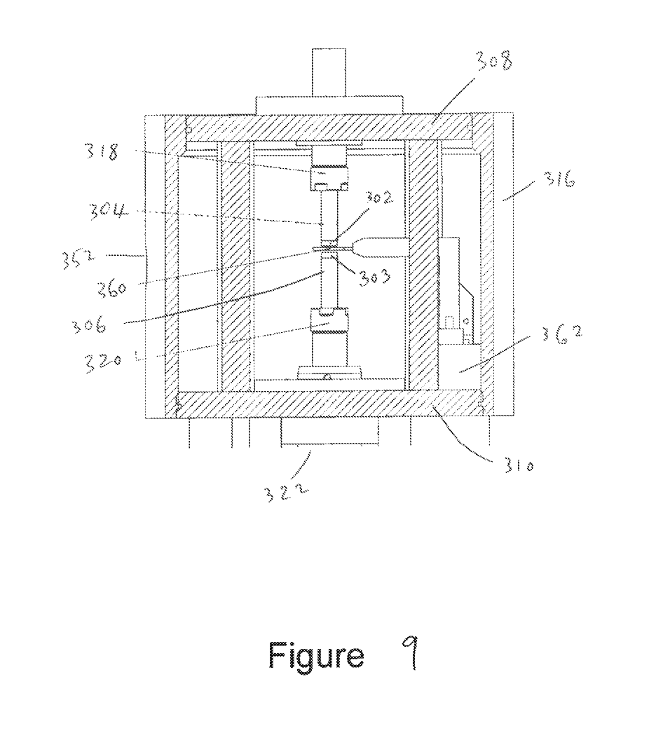

In use, as shown in FIGS. 8 and 9, the induction coil 360 is positioned between the bevelled end portions 302 and 303 and the electrical supply 334 is activated so as to drive a high frequency alternating current through the induction coil 360 thereby inductively heating the bevelled specimen end portions 302 and 303.

The apparatus 301 further comprises an IR camera 350 (FIG. 8) which is configured to remotely sense a temperature of the bevelled end portions 302 and 303 through a sapphire window 352 in the enclosure 316. Furthermore, the apparatus 301 comprises a position sensor 354 configured for measurement of a position of the actuator 322 relative to the lower plate 310 and a force sensor 356 configured for measurement of a force exerted by the specimen actuator 322 on the lower pipe specimen 306. The apparatus 301 further comprises a controller 358 configured for communication with the specimen actuator 322, the electrical supply 334, the IR camera 350, the position sensor 354 and the force sensor 356 as indicated by the dotted lines in FIG. 8.

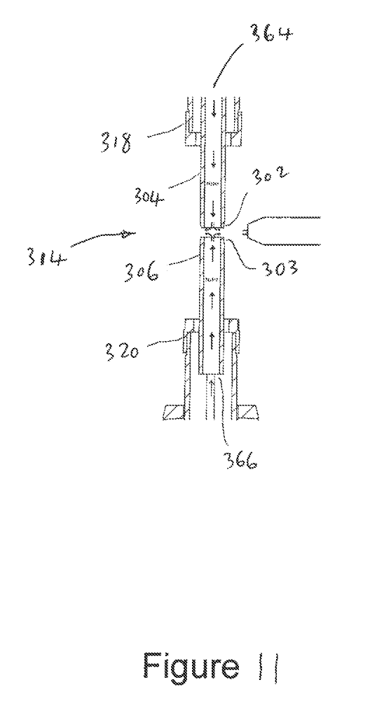

The upper and lower pipe specimens 304, 306 comprise ends 364 and 366 opposite to the bevelled end portions 302, 303 respectively. As shown in FIG. 11, the specimen ends 364, 366 together serve as an inlet for supplying a reducing gas comprising nitrogen and hydrogen through the upper and lower pipe specimens 304, 306 to the bevelled end portions 302, 303 respectively. The apparatus 301 further comprises a reducing gas outlet (not shown) from the space 314 for the reducing gas. The specimen ends 364, 366 and the reducing gas outlet are connected to a reducing gas supply 359. The reducing gas supply 359 is configured to control a temperature, pressure, composition and flow rate of the reducing gas. The reducing gas supply 359 is also configured for communication with the controller 358.

The apparatus 301 comprises a cooling arrangement for cooling or quenching portions of the upper and lower pipe specimens 304, 306 adjacent to the bevelled end portions 302, 303 respectively. The cooling arrangement is a closed-loop coolant fluid arrangement comprising a coolant fluid supply 367 for supplying and controlling a temperature and a flow rate of a cooling fluid, an upper coolant fluid chamber 368 surrounding an intermediate portion of the upper pipe specimen 304 adjacent to the bevelled end portion 302 and a lower coolant fluid chamber 370 surrounding an intermediate portion of the lower pipe specimen 306 adjacent to the bevelled end portion 303. The coolant fluid arrangement further comprises a coolant fluid pipe 372 that connects the upper coolant fluid chamber 368 to the lower coolant fluid chamber 370, a coolant fluid inlet pipe 374 that connects the upper coolant fluid chamber 368 to the coolant fluid supply 367 and a coolant fluid outlet pipe 376 that connects the lower coolant fluid chamber 370 to the coolant fluid supply 367. The coolant fluid supply 367 is also configured for communication with the controller 358.

In use, the controller 358 controls the actuator 322, the electrical supply 334, the reducing gas supply 359 and/or the coolant fluid supply 367 according to a temperature sensed by the IR camera 350, a position sensed by the position sensor 354 and/or a force sensed by the force sensor 356 so as to subject one or both of the bevelled end portions 302 and 303 of the upper and lower pipe specimens 304 and 306 to a controlled welding process step. In the case of the heating step 8 of the method 2 of FIG. 1, for example, the apparatus 301 is used to control the evolution as a function of time of a spatial temperature distribution across one or both of the bevelled end portions 302, 303 in an atmosphere of reducing gas having a predetermined temperature, pressure, composition and flow rate. In the case of the welding step 108 of the method 102 of FIG. 3, for example, the apparatus 301 is used to control the evolution as a function of time of a spatial temperature distribution across both of the bevelled end portions 302 and 303 in an atmosphere of reducing gas having a predetermined temperature, pressure, composition and flow rate and to control the movement of and the forces applied to the upper and lower pipe specimens 304, 306 during forge welding thereof.

It should be understood that the embodiments described herein are merely exemplary and that modifications may be made thereto without departing from the scope of the present invention. For example, the apparatus 201, 301 may comprise a sensor for measuring a shape, size, surface profile, microstructure or any other structural property of a specimen or specimens during or after subjecting the specimen or specimens to a controlled welding process step. In use the controller 258, 358 may control the actuator 222, 322, the electrical supply 234, 334, the reducing gas supply 259, 359 and/or the coolant fluid supply 367 according to a temperature sensed by the IR camera 250, 350, a position sensed by the position sensor 254, 354, a force sensed by the force sensor 256, 356 and/or a measured value of the structural property of the specimen or specimens. The apparatus 201, 301 may also be used in the specimen measurement steps 10 and 110 of the methods 2 and 102 of FIGS. 1 and 3 respectively. For example, a sensor for measuring a shape, size, surface profile, microstructure or any other structural property of a specimen or specimens may be used in the specimen measurement steps 10 and 110 of the methods 2 and 102 of FIGS. 1 and 3 respectively. In addition to or as an alternative to using an IR camera 250, 350 to measure a temperature of the specimen or specimens, a pyrometer, thermal camera, thermocouple, thermistor, or any other kind of temperature sensor may be used.

Although the apparatus 201 illustrated in FIGS. 4 to 7 has upper and lower pairs of electrodes 224, 226 which are used to resistively heat coupon specimens 204, 206 having bevelled end portions 202, 203, while the apparatus 301 illustrated in FIGS. 7 to 9 has an induction coil 360 used to inductively heat generally pipe-shaped specimens 304, 306 having bevelled end portions 302, 303, it should be understood that either apparatus 201, 301 may be used to heat one or more specimens of different shapes. In addition, an apparatus for use in heating one or more specimens may comprise at least one pair of electrodes and an induction coil. Such an apparatus may be used to simultaneously resistively and inductively heat the one or more specimens. The at least one pair of electrodes may be used to heat the one or more specimens in preparation for welding whilst the induction coil may be used to heat treat the one or more specimens after welding.

1. A method for determining a welding process parameter for an object, comprising:
subjecting a specimen removed from the object to a controlled specimen welding process;
measuring a property of the specimen; and
determining a welding process parameter associated with the object from the measured specimen property and the controlled specimen welding process.

2. The method according to claim 1, comprising removing the specimen from the object.

3. The method according to claim 1, comprising removing the specimen from a pipe.

4. The method according to claim 1, comprising removing a portion of a curved wall of a pipe.

5. The method according to claim 1, comprising processing the specimen so as to have a predetermined feature.

6. The method according to claim 1, comprising processing the specimen so as to have a cylindrical or rod shape.

7. The method according to claim 1, comprising forming a geometrical feature on an end portion of the specimen.

8. The method according to claim 1, comprising forming the specimen so that the specimen can be used directly for tensile testing.

9. The method according to claim 1, comprising subjecting the specimen to a controlled specimen welding process step for a predetermined period of time.

10. The method according to claim 1, comprising controlling a property of the specimen including at least one of temperature, stress, size, shape, surface profile, surface roughness, surface finish, microstructure, chemistry, metallurgy, resistance, resilience, ductility, hardness, strength and a visco-plastic material parameter.

11. The method according to claim 1, comprising controlling the application of an external stimulus to the specimen including at least one of heat, pressure, force, current, voltage, electric power, electromagnetic power, electric field, magnetic field, acoustic power and ultrasonic power.

12. The method according to claim 1, comprising exposing at least a portion of the specimen to a controlled environment.

13. The method according to claim 12, wherein the controlled environment comprises a fluid, including at least one of a reducing gas, inert gas, and cooling fluid.

14. The method according to claim 1, comprising adjusting a temperature of at least a portion of the specimen to a target temperature.

15. The method according to claim 1, comprising adjusting a temperature of at least a portion of the specimen to a target temperature within a target time period.

16. The method according to claim 1, comprising subjecting a body to the same controlled specimen welding process step to which the specimen is subjected.

17. The method according to claim 16, wherein the body comprises a further specimen removed from the object.

18. The method according to claim 16, wherein the step of subjecting the specimen to a controlled specimen welding process step comprises engaging the specimen with the body under controlled conditions.

19. The method according to claim 16, forge welding the specimen and the body.

20. The method according to claim 1, comprising measuring a property of the specimen before, during and/or after the step of subjecting the specimen to the controlled specimen welding process step.

21. The method according to claim 1, comprising mechanical testing of the specimen.

22. The method according to claim 1, comprising measuring a weld shape.

23. The method according to claim 1, comprising:
subjecting a further specimen removed from the object to a controlled specimen welding process;
measuring a property of the further specimen; and
determining a welding process parameter associated with the object from the measured property of the further specimen, and the controlled specimen welding process to which the further specimen is subjected.

24. The method according to claim 23, comprising correlating properties measured from the specimen and the further specimen.

25. The method according to claim 23, comprising correlating welding process parameter determined from the specimen and the further specimen.

26. The method according to claim 23, wherein the further specimen has a different shape and/or size to the specimen.

27. The method according to claim 1, comprising using a mathematical model of the specimen to calculate the object welding process parameter from the measured specimen property and the controlled specimen welding process.

28. The method according to claim 1, comprising using a finite element mathematical model of the specimen to calculate the object welding process parameter from the measured specimen property and the controlled specimen welding process.

29. The method according to claim 1, comprising validating a mathematical model of the specimen welding process.

30. The method according to claim 1, comprising comparing a value of the specimen property predicted using a mathematical model with a measured value of the specimen property.

31. The method according to claim 30, comprising improving a mathematical model based on a comparison between a value of the specimen property predicted using the mathematical model and a measured value of the specimen property.

32. The method according to claim 1, comprising deeming a mathematical model to be valid when a difference between a value of the specimen property predicted using the mathematical model and a measured value of the specimen property is less than a predetermined accuracy value.

33. The method according to claim 1, comprising adjusting a mathematical model according to a difference between a value of the specimen property predicted using the mathematical model and a measured value of the specimen property.

34. An apparatus for use in the method according to claim 1.

35. The apparatus according to claim 34, configured to subject the specimen to a controlled specimen welding process.

36. The apparatus according to claim 35, configured to subject a further specimen to a controlled specimen welding process.

37. The apparatus according to claim 34, comprising a specimen enclosure for enclosing at least a portion of the specimen in a controlled environment.

38. The apparatus according to claim 34, comprising an electrical heating arrangement for heating at least a portion of the specimen.

39. The apparatus according to claim 38, wherein the electrical heating arrangement comprises at least one of an induction heating arrangement and electrode resistive heating arrangement.

40. The apparatus according to claim 34, comprising a pair of plates and at least one tension rod connecting the pair of plates so as to form a frame configured to support the specimen.

41. The apparatus according to claim 34, comprising a specimen feeding arrangement for feeding specimens into a specimen holding arrangement.

42. The apparatus according to claim 41, comprising a specimen carousel for feeding specimens into the specimen holding arrangement.

43. The apparatus according to claim 34, configured to hold a body.

44. The apparatus according to claim 43, wherein the apparatus is configured to bring the specimen and the body into contact.

45. The apparatus according to claim 44, configured to exert a force between the specimen and the body.

46. The apparatus according to claim 43, comprising a specimen actuator for urging the specimen towards the body.

47. The apparatus according to claim 46, wherein the specimen actuator is attached to a frame.

48. The apparatus according to claim 34, comprising a sensor for measuring a property of the specimen.

49. The apparatus according to claim 48, wherein the sensor is configured to measuring a property of the specimen at or adjacent to a weld interface between the specimen and a body to which the specimen is welded.

50. The apparatus according to claim 34, comprising a temperature sensor for measuring a temperature of the specimen, wherein the temperature sensor includes at least one of a pyrometer, thermal camera, thermometer, thermocouple, thermistor and resistance temperature detector.

51. The apparatus according to claim 34, configured to perform pull and/or hardness tests after subjecting the specimen to a controlled specimen welding process using the apparatus.

52. The apparatus according to claim 34, comprising one or more specimen environment sensors for measuring a property of an environment to which at least a portion of the specimen in exposed.
